(19) United States
(12) Patent Application Publication
(10) Pub. No.: US 2016/0055443 A1
(43) Pub. Date: Feb. 25, 2016

(54) GENERATING ORGANIZATIONAL MENTORING RELATIONSHIPS

(71) Applicant: International Business Machines Corporation, Armonk, NY (US)

(72) Inventors: Yi-Min Chee, Yorktown Heights, NY (US); Wesley M. Gifford, Ridgefield, CT (US); Ashish Jagmohan, Irvington, NY (US); Anshul Sheopuri, Teaneck, NJ (US)

(21) Appl. No.: 14/466,152

(22) Filed: Aug. 22, 2014

(51) Int. Cl. G06Q 10/06; G06F 17/30

(52) U.S. Cl. CPC G06Q 10/063112; G06F 17/30876

(57) ABSTRACT

A tool for computational generation of organizational mentoring relationships. The tool determines a mentor pool and a mentee pool based, at least in part, on per-person domain metric data for each person in a general pool. The tool determines a plurality of per-metric ranked mentor lists for each of the one or more mentees in the mentee pool. The tool determines a per-mentee fused rank list for each of the one or more mentees in the mentee pool. The tool determines, based, at least in part, on the per-mentee fused rank list for each of the one or more mentees in the mentee pool, one or more cross-organizational mentorship assignments. The tool establishes, based, at least in part, on the one or more cross-organizational mentorship assignments, at least one mentor-mentee relationship for each of the one or more mentees in the mentee pool.

### BACKGROUND OF THE INVENTION

The present invention relates generally to computer analytics, and more particularly to computationally establishing organizational mentoring relationships.

Mentoring is a process for transmission of knowledge, social capital, and the psycho-social support perceived by a recipient as relevant to work, career, or professional development; mentoring entails informal communication, usually face-to-face and during a sustained period of time, between a person who is perceived to have greater relevant knowledge, wisdom, or experience (the mentor) and a person who is perceived to have less (the mentee).

Corporate mentoring programs are used by mid to large organizations to further the development and retention of employees. Mentoring programs may be formal or informal and serve a variety of specific objectives including acclimation of new employees, skills development, employee retention, and diversity enhancement. Formal mentoring programs offer employees the opportunity to participate in an organized mentoring program. Participants join as a mentor, a mentee, or both by completing a mentoring profile. Mentoring profiles are completed as written forms on paper or computer or filled out via an online form as part of an online mentoring system. Mentees are matched with a mentor by a program administrator or a mentoring committee, or may self-select a mentor depending on the program format. Informal mentoring takes places in organizations that develop a culture of mentoring, but do not have formal mentoring in place. These companies may provide some tools and resources for developing mentoring relationships, and encourage managers to accept mentoring requests from more junior members of the organization.

### SUMMARY

Aspects of an embodiment of the present invention disclose a method, system, and computer program product for computational generation of organizational mentoring relationships. The method includes determining, by one or more computer processors, a mentor pool and a mentee pool based, at least in part, on per-person domain metric data for each person in a general pool, wherein the mentor pool includes one or more mentors and the mentee pool includes one or more mentees. The method further includes determining, by one or more computer processors, a plurality of per-metric ranked mentor lists for each of the one or more mentees in the mentee pool, wherein the plurality of per-metric ranked mentor lists include one or more potential mentors. The method further includes determining, by one or more computer processors, a per-mentee fused rank list for each of the one or more mentees in the mentee pool, wherein the per-mentee fused rank list includes at least one of the one or more potential mentors from the plurality of per-metric ranked mentor lists. The method further includes determining, by one or more computer processors, based, at least in part, on the per-mentee fused rank list for each of the one or more mentees in the mentee pool, one or more cross-organizational mentorship assignments. The method further includes establishing, by one or more computer processors, based, at least in part, on the one or more cross-organizational mentorship assignments, at least one mentor-mentee relationship for each of the one or more mentees in the mentee pool.

### BRIEF DESCRIPTION OF THE SEVERAL VIEWS OF THE DRAWINGS

FIG. 1 is a functional block diagram illustrating a data processing environment, generally designated 100, in accordance with an embodiment of the present invention.

FIG. 2 is a flowchart of an exemplary process flow, generally designated 200, for computational generation of organizational mentoring relationships, in accordance with an embodiment of the present invention.

FIG. 3 is a block diagram depicting components of a data processing system (such as server 104 of FIG. 1), in accordance with an embodiment of the present invention.

### DETAILED DESCRIPTION

Embodiments of the present invention recognize that vocational behavior research on mentoring supports the use of consistent, unbiased, computational techniques for forming mentoring relationships.

Embodiments of the present invention provide the capability to provide consistent, unbiased relationship formation suitable in large organizations with large numbers of mentors and mentees. Embodiments of the present invention provide the capability to determine high quality relationships that jointly optimize mentor load and cross-organizational quality.

Implementation of such embodiments may take a variety of forms, and exemplary implementation details are discussed subsequently with reference to the Figures.

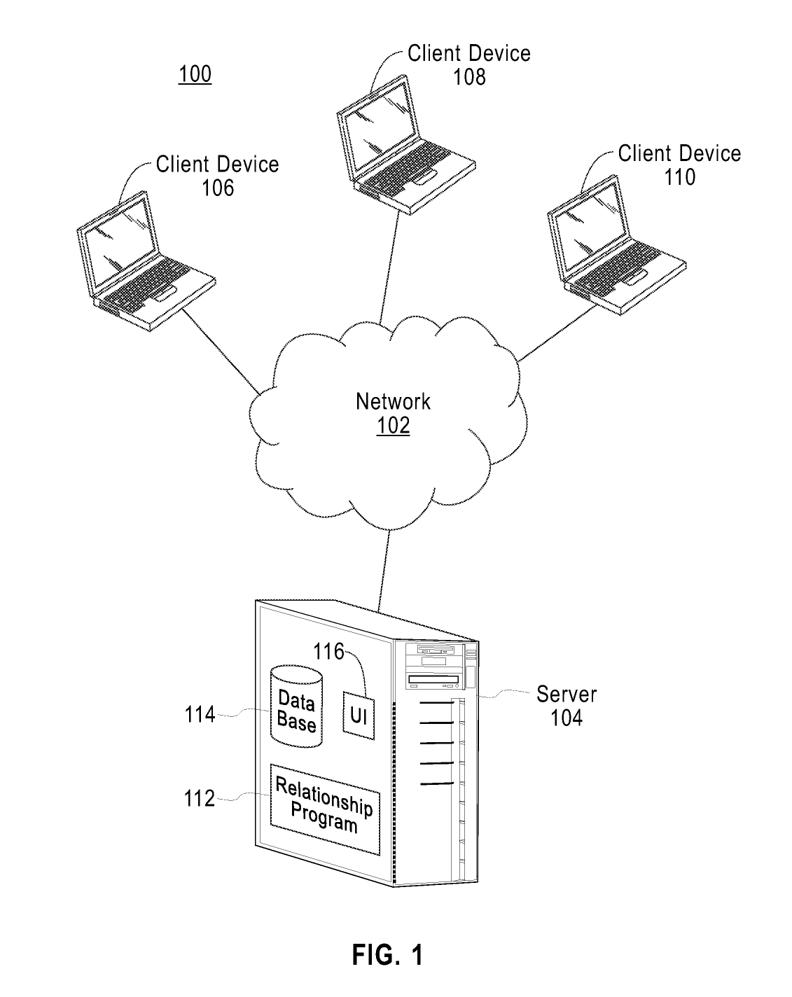

The present invention will now be described in detail with reference to the Figures. FIG. 1 is a functional block diagram illustrating a data processing environment, generally designated 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims. Data processing environment 100 includes network 102, server 104, and multiple client devices, such as client device 106, client device 108, and client device 110.

In the exemplary embodiment, network 102 is the Internet representing a worldwide collection of networks and gateways that use TCP/IP protocols to communicate with one another. Network 102 may include wire cables, wireless communication links, fiber optic cables, routers, switches and/or firewalls. Server 104, client device 106, client device 108, and client device 110 are interconnected by network 102. Network 102 can be any combination of connections and protocols capable of supporting communications between server 104, client device 106, client device 108, client device 110 and relationship program 112. Network 102 may also be implemented as a number of different types of networks, such as an intranet, a local area network (LAN), a virtual local area network (VLAN), or a wide area network (WAN). FIG. 1 is intended as an example and not as an architectural limitation for the different embodiments.

In the exemplary embodiment, server 104 may be, for example, a server computer system such as a management server, a web server, or any other electronic device or computing system capable of sending and receiving data. In another embodiment, server 104 may be a data center, consisting of a collection of networks and servers providing an IT service, such as virtual servers and applications deployed on virtual servers, to an external party. In another embodiment, server 104 represents a “cloud” of computers interconnected by one or more networks, where server 104 is a computing system utilizing clustered computers and components to act as a single pool of seamless resources when accessed through network 102. This is a common implementation for data centers in addition to cloud computing applications. In the exemplary embodiment, server 104 includes a relationship program 112, a database 114, and a user interface (UI) 116.

In the exemplary embodiment, server 104 includes relationship program 112 for computationally establishing mentorship relationships in organizations. Relationship program 112 utilizes a rank fusion learning framework, which incorporates insights from psycho-social research, to determine relationship strength rankings from a plurality of metrics. Relationship program 112 utilizes a bipartite graph-matching framework to optimize cross-organizational relationship strength while constraining per-mentor load. Relationship program 112 leverages a feedback mechanism to capture a human element to automatically adjust the rank fusion learning based, at least in part, on historical mentoring data (i.e., mentor preferences, mentee preferences, post-action evaluations, etc.). In the exemplary embodiment, relationship program 112 can be configured to establish mentorship relationships across varying domains (e.g., business mentorship organizations, youth mentorship, etc.), relationship types (e.g., peer mentoring, asymmetric relationships, etc.), and mentoring goals (e.g., targeted skill development, cross-functional development, etc.).

In the exemplary embodiment, relationship program 112 operates on a central server, such as server 104, and can be utilized by one or more client devices, such as client device 106, client device 108, and client device 110, for example, where client device 106 is utilized by a manager, client device 108 is a mentorship administrator, and client device 110 is a mentor/mentee. In another embodiment, relationship program 112 may be a software-based program, downloaded from a central server, such as server 104, and installed on one or more client devices, such as client device 106, client device 108, and client device 110. In yet another embodiment, relationship program 112 may be utilized as a software service provided by a third-party (not shown).

In the exemplary embodiment, client device 106, client device 108, and client device 110 are clients to server 104 and may be, for example, a desktop computer, a laptop computer, a tablet computer, a personal digital assistant (PDA), a smart phone, a thin client, or any other electronic device or computing system capable of communicating with server 104 through network 102. For example, client device 108 may be a desktop computer utilized by a mentorship administrator in an organization to connect with server 104 to execute relationship program 112.

In an alternate embodiment, client device 106, client device 108, and client device 110 may be any wearable electronic device, including wearable electronic devices affixed to eyeglasses and sunglasses (e.g., Google Glass®), wristwatches, clothing, wigs, and the like, capable of sending, receiving, and processing data. For example, client device 106, client device 108, and client device 110 may be a wearable electronic device, such as a wristwatch, capable of communicating with server 104 to execute relationship program 112.

In the exemplary embodiment, server 104 includes database 114 for storing information related to establishing mentorship relationships.

In the exemplary embodiment, server 104 includes UI 116 for providing operation and control of relationship program 112 to one or more client devices, such as client device 106, client device 108, and client device 110. In the exemplary embodiment, UI 116 can be a graphical user interface, a web-based user interface, or any other suitable user interface capable of accepting input and providing output to facilitate communication between one or more users, such as a mentorship administrator, a mentor and a mentee, and relationship program 112. In one embodiment, UI 116 can function as a mechanism for providing feedback relating to established mentoring relationships (i.e., mentors and mentees can participate in post-action evaluations of relationship quality). For example, a user, such as a mentor, can express mentor preferences (i.e., preference for a particular mentee) and provide a post-action evaluation of mentoring relationship quality through UI 116.

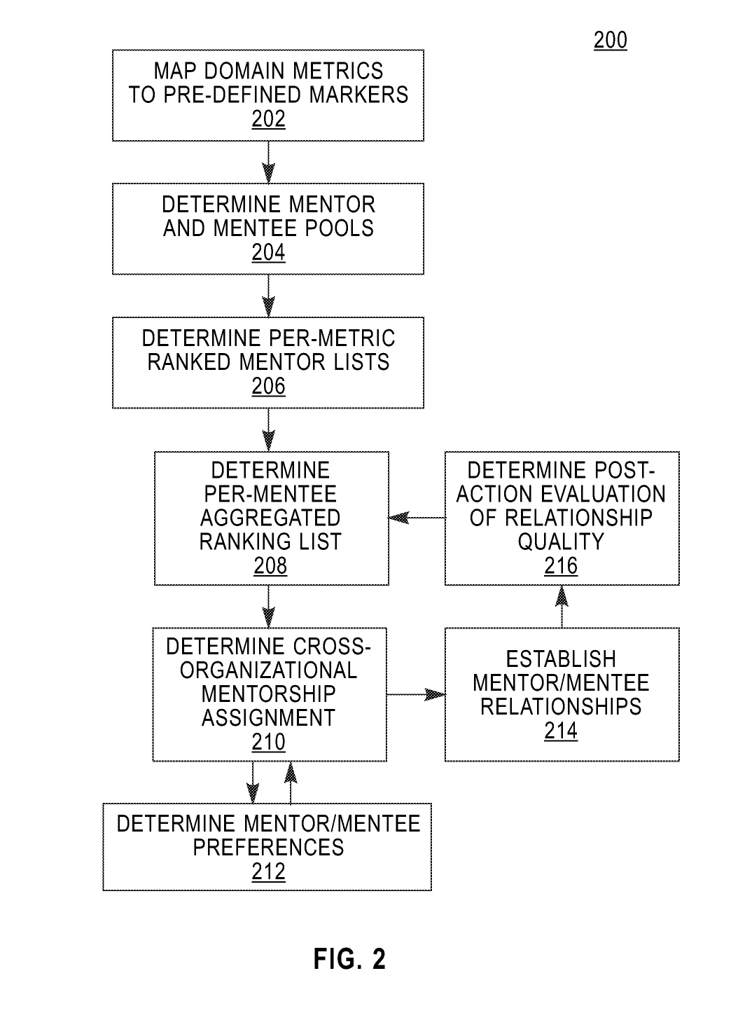

FIG. 2 is a flowchart of an exemplary process flow, generally designated 200, for computational generation of organizational mentoring relationships, in accordance with an embodiment of the present invention.

Relationship program 112 maps one or more domain metrics to a plurality of pre-defined markers (202). In the exemplary embodiment, relationship program 112 maps the one or more domain metrics, including, without limitation, a business sector, a business account, a client history, a targeted skill, geographical and availability indicators, and Myers-Briggs Type Indicator (MBTI) analysis, to the plurality of pre-defined psycho-social markers, including, without limitation, an experiential similarity marker, a perceived similarity marker, an interaction facilitator marker, and a personality compatibility marker, in a semi-automatic manner. In the exemplary embodiment, relationship program 112 utilizes data mining techniques to retrieve a plurality data relevant to the one or more domain metrics from a variety of databases, such as database 114 (e.g., employee records, performance evaluations, business unit, employee profiles, etc.).

Relationship program 112 maps the plurality of data for the one or more domain metrics into a corresponding marker from the plurality of pre-defined psycho-social markers. For example, relationship program 112 can map data relevant to one or more domain metrics, such as a sector, an industry, an account, or a client history to an experiential similarity marker designed to evaluate how similar a mentor and mentee are relative to one another based on the individual experience of the mentor and the mentee; the closer aligned the mentor and mentee are with respect to their experience, the more successful the mentorship relationship will be, as generally understood from prior results in mentoring relationships generated around experiential similarity. In another example, relationship program 112 can map data relevant to one or more domain metrics, such as geographical and availability indictors (e.g., region, location, proximity, availability, etc.) to an interaction facilitator marker designed to evaluate an ability of both the mentor and mentee to spend a significant amount of time together to foster a productive mentorship relationship; the more interaction between a mentor and a mentee, the more productive the mentoring relationship, as generally understood from prior results in mentorship relationships. In another example, relationship program 112 can map data relevant to one or more domain metrics, such as technical interests and business goals, to a perceived similarity marker designed to evaluate how similar a mentor and mentee would perceive each other's interests and goals to be (e.g., a mentor may perceive a mentee as similar to themselves where the mentor and mentee are both interested in improving global sales and each have a degree in marketing, as noted on their respective employee profiles); the closer aligned the mentor and mentee are with respect to their perceived goals, the more successful the mentorship relationship will be, as generally understood from prior results in mentoring relationships generated around perceived similarities.

In the exemplary embodiment, relationship program 112, based, at least in part, on the domain (i.e., business organization, peer-to-peer, etc.) and the relationship type (i.e., asymmetric targeted skill development, peer-to-peer mentorship, asymmetric mentorship, etc.), prioritize each of the plurality of psycho-social markers by assigning a weight to each marker, wherein the weight assigned to each of the plurality of psycho-social markers is based, at least in part, on desired relationship goals and outcomes. For example, in the context of a business organization formal mentorship, where an asymmetric targeted skill development relationship is desired, relationship program 112 can prioritize each of the plurality of psycho-social markers by assigning a high weight to an experiential similarity marker, a highly influential marker relative to achieving success in the desired relationship, and a low weight to a personality compatibility marker, a less influential marker relative to achieving success in the desired relationship. In another example, in the context of a peer-to-peer mentorship, relationship program 112 can assign a high weight to a perceived similarity marker, a highly influential marker relative to achieving success in the desired relationship, and a low weight to an experiential similarity marker, a less influential marker relative to achieving success in the desired relationship. In another embodiment, relationship program 112 can learn how to prioritize each of the plurality of psycho-social markers based, at least in part, on the actual success of the mentoring relationship based on a previous prioritization, wherein the actual success of the mentoring relationship, as indicated by a post-action evaluation of relationship quality, is discussed in a subsequent step.

Relationship program 112 determines mentor and mentee pools (204). In the exemplary embodiment, relationship program 112 determines mentor and mentee pools from a general pool of people based, at least in part, on per-person domain metric data for each person in the general pool of people. In the exemplary embodiment, relationship program 112 determines mentor and mentee pools by separating each person in the general pool of people into a mentor pool or a mentee pool based, at least in part, on one or more key traits and one or more pool constraints (e.g., a high performers relative to the one or more key traits indicates a potential mentor), wherein the one or more key traits and the one or more pool constraints are established by, for example, an administrator, a manager, or relationship program 112 (i.e., default setting) relative to the type of mentoring relationship desired.

In the exemplary embodiment, relationship program 112 identifies each person from the general pool of people with high performance relative to the one or more key traits (i.e., a person possesses a key trait, a person's data suggests they possess a key trait, etc.) and separates those people into the mentor pool, while other people are separated into the mentee pool. For example, in the context of a business organization mentorship where corporate executive relations may be a quality specified as a key trait, relationship program 112 can identify a person from the general pool of people possessing extensive experience in corporate executive relations and separate the person from the general pool to the mentor pool. In another example, in the context of a youth mentorship where strong academic performance may be a quality specified as a key trait, relationship program 112 can identify a person from the general pool of people exhibiting high academic performance and separate the person from the general pool to the mentor pool.

In another embodiment, additional constraints can be specified to filter mentor and mentee pools. For example, in addition to possessing key traits, relationship program 112 can filter a person from the general pool of people by years of experience, where only a person possessing 10 years of experience in a business area specified as a key trait is considered as a potential mentor (i.e., considered for separation from the general pool to the mentor pool). In yet another example, relationship program 112 can filter a person from the general pool of people by years of experience, where only a person possessing less than 5 years of experience in a business area specified as a key trait is considered as a potential mentee (i.e., considered for separation from the general pool to the mentee pool).

Relationship program 112 determines per-metric ranked mentor lists (206). In the exemplary embodiment, relationship program 112 determines a plurality of per-metric ranked mentor lists for each mentee in the mentee pool. In the exemplary embodiment, for each mentee in the mentee pool, relationship program 112 determines a separate ranked list of potential mentors (i.e., per-metric ranked mentor lists) for each of the one or more domain metrics in each of the plurality of psycho-social markers. The potential mentors are ranked against each other within the separate ranked list based, at least in part, on each of the potential mentors' data relative to the domain metric being constrained by the separate ranked list. Ranking potential mentors by their performance (i.e., their individual compatibility with the mentee based on the domain metric isolated by the separate ranked list) relative to each other can change depending on what domain metric is being isolated. For example, an experiential similarity marker may contain two domain metrics, such as metric λ₁ and metric λ₂. For a specific mentee, for metric λ₁, three potential mentors, mentor M1, mentor M2, and mentor M3 are ranked in a first separate ranked list according to their performance against each other relative to their individual compatibility with the specific mentee, based, at least in part, on the requirements of metric λ₁. Mentor M2 may be the highest performer among the three potential mentors, and as such, will be ranked higher than mentor M3 and mentor M1. Similarly, for metric λ₂, the three potential mentors are ranked in a second separate ranked list according to their performance against each other relative to their individual compatibility with the specific mentee based, at least in part, on the requirements of metric λ₂. Mentor M1 may be the highest performer among the three potential mentors, and as such, will be ranked higher than mentor M3 and mentor M2. In the exemplary embodiment, relationship program 112 determines a plurality of separate ranked lists of potential mentors for each of the members of the mentee pool (i.e., mentees), where the plurality of separate ranked lists includes a separate ranked list of potential mentors for each of the one or more domain metrics associated with each of the plurality of psycho-social markers.

Relationship program 112 determines per-mentee aggregated (fused) ranked lists (208). In the exemplary embodiment, relationship program 112 determines a per-mentee fused list for each of the mentees in the mentee pool. As discussed above, for each mentee relationship program 112 determines a ranked list of mentors for each of the one or more domain metrics associated with the plurality of psycho-social markers. For example, a given mentee may have ten different ranked lists of possible mentors, each list ranking the possible mentors based, at least in part, on their individual compatibility with the mentee based, at least in part, on each of the one or more domain metrics (e.g., industry, geography, client history, etc.).

In the exemplary embodiment, relationship program 112 performs a rank fusion to fuse the multiple rankings for each of the potential mentors into a single fused mentor list, while damping outlier divergent ranking domain metrics. For example, where six of the ten separate ranked lists are largely in agreement (i.e., the rankings are similar relative to the one or more domain metrics for each of the possible mentors), and four of those separate ranked lists are widely in disagreement, relationship program 112 applies a rank fusion intuition to damp affects of outlier ranked lists (i.e., weight an outlier ranked lists lower to lessen its influence on mentor suitability), as those separate ranked lists widely in disagreement are likely not accurate in terms of characterizing mentor suitability.

In the exemplary embodiment, relationship program 112 performs a global trust determination, wherein the global trust determination includes determining a trust factor for each of the separate ranked lists of possible mentors, and based, at least in part, on the trust factor, relationship program 112 determines a single fused mentor list. In the exemplary embodiment, relationship program 112 determines the trust factor for each of the separate ranked lists by determining a level of agreement between all of the separate ranked lists of possible mentors, and those separate ranked lists indicating agreement (i.e., closeness between scores for each mentor-mentee pairing) are determined to be trustworthy. For example, in the case of 1000 mentees and one domain metric, relationship program 112 determines 1000 ranked lists of mentors. In the case of 10 domain metrics, relationship program determines ten sets of 1000 ranked lists of mentors. Relationship program 112, by determining a level of agreement between ranked lists of possible mentors and mentee lists, determines a single fused mentor list for a single mentee, including all mentors determined to be a quality match for the mentee. By damping down outliers, ranked lists of possible mentors determined to exhibit a lower trust factor (i.e., less trustworthy lists) have reduced influence on the single fused mentor list, whereas ranked lists of possible mentors determined to exhibit a higher trust factor (i.e., more trustworthy lists) have a greater influence on the single fused mentor list. For example, in the case of 1000 mentees, 1000 mentors, and 10 metrics, for each mentee, relationship program 112 determines ten ranked lists of possible mentors. Relationship program 112 determines ten possible quality values for each possible mentor-mentee pairing. Of the ten possible scores for each pairing, some scores will be in agreement, and some will be in disagreement. For the 1000 mentees and the 1000 mentors, relationship program 112 determines the agreement between the ten scores for each pairing (i.e., a mean or median). Scores close to the mean or median are considered in agreement, whereas scores not close to the mean or median are considered in disagreement (i.e., outliers). In the exemplary embodiment, relationship program 112 learns a threshold mean-median in an unsupervised fashion; the threshold mean-median is not an input parameter.

In the exemplary embodiment, relationship program determines per-mentee fused ranking lists algorithmically, wherein prioritization of psycho-social markers based on relationship type and feedback on historical mentor-mentee relationship quality are incorporated into the per-mentee fused ranking lists. In the exemplary embodiment, relationship program 112 utilizes a function Σwᵢ[rᵢ(m, M, λᵢ)−μ(m,M)]. In the function, rᵢ is a mentor-mentee ranking, or compatibility score, as defined as a function of m (mentee), M (mentor), and domain metric λᵢ, minus the μ (mean/median) rank/score for a given mentee-mentor pairing. The difference between rᵢ and μ determines how much a specific domain metric disagrees with the mean/median metric for a given mentor-mentee combination. The function determines a weighted sum (wᵢ), and determines weights that minimize the weighted sum. Weights that minimize the weighted sum indicate a trust factor. It follows that metrics with small corresponding w's after global trust optimization indicate metrics that disagree with the mean/median score, since those metrics have a high difference between rᵢ and μ. In the exemplary embodiment, the summation of the weights is constrained to 1. The forgoing global optimization yields weights that are roughly the trust factor for a given mentor-mentee combination. In the exemplary embodiment, relationship program 112 fuses ranked lists of possible mentors possessing a high trust factor. In the exemplary embodiment, in order to incorporate prioritization of psycho-social markers based on relationship type, relationship program 112 constrains at least one of the w's for metrics to be strictly larger than other metrics. In the exemplary embodiment, in order to incorporate feedback on historical mentor-mentee relationship quality, relationship program 112 modifies the μ (mean/median) score for known mentor-mentee pairings that have performed poorly or performed well by inputting historical information into the μ (mean/median) score. For example, in the case of a mentor-mentee pairing performing poorly, relationship program 112 assigns a small value for μ, even if the (mean/median) score of the domain metrics is large.

Relationship program 112 determines cross-organizational mentorship assignments (210). In the exemplary embodiment, relationship program 112 determines cross-organizational mentorship assignments to maximize the quality of a recommended mentor-mentee pairing, while ensuring that no single mentor is over-loaded with too many mentee assignments. For example, a single mentor can be the best possible match for 100 mentees. Cross-organizational optimization balances quality of the mentor-mentee pairing and individual mentor load. In the exemplary embodiment, relationship program 112 achieves cross-organizational optimization by solving for a bipartite graph mapping problem. In the mathematical field of graph theory, a bipartite graph (or bigraph) is a graph whose vertices can be divided into two disjoint sets M (e.g., mentors) and m (e.g., mentees), that is, M and m are each independent sets. In the bigraph every edge (i.e., line) connects a vertex in M to one in m. Vertex set M and m are often denoted as partite sets. For example, mentees are oriented on the bottom of a map in the m set, mentors are oriented on the top of the map in the M set, and edges connecting the mentors and the mentees together are representative of the relationship quality between the connected mentors and mentees, as previously determined in prior sets. In the exemplary embodiment, relationship program 112 algorithmically determines a subset of edges, where the sum of the edge weights is maximized under a constraint that no single mentor can be assigned, for example, more than 5 edges and no mentee can be assigned, for example, more than 3 mentors. Relationship program 112 determines edges to maximize the sum of the overall edge weights, under the constraints that the degree of the mentor (i.e., the number of edges attached to a single mentor) is less than a pre-specified maximum degree, and the degree of the mentee (i.e., the number of edges attached to a single mentee) is less than a pre-specified maximum degree.

Relationship program 112 determines mentor-mentee preferences (212). In the exemplary embodiment, relationship program 112 determines mentor-mentee preferences to enhance the quality of mentor-mentee pairings by injecting a human element into the assignment determination. For example, where the aim is to assign three mentors per mentee, relationship program 112 determines six mentors to pair to each mentee. Each mentor and mentee receives a predefined number of vetoes that the mentor and mentee can exercise to turn down an assignment to a mentee or a mentor they do not wish to be paired with. In the exemplary embodiment, relationship program 112 provides unidentifiable information to the mentor and the mentee to base a preference decision on while still providing a level of anonymity within the process. In one embodiment, mentor-mentee preferences processes are handled at the organizational level, where experts put in their human preference, based, at least in part, through manual assignment of mentor-mentee pairings based on prior knowledge of mentor-mentee combinations. In the exemplary embodiment, relationship program 112 considers mentor-mentee preferences in determining cross-organization mentorship assignments. For example, if a mentor exercises a veto for a particular mentee, relationship program 112 adjusts the edges in the bipartite graph mapping problem to reflect that the mentor cannot be paired with that particular mentee, adjusting edge weights accordingly throughout the graph.

Relationship program 112 establishes mentor-mentee relationships (214). In the exemplary embodiment, relationship program 112 establishes mentor-mentee relationships (pairings), by confirming an assignment of one or more mentors to a mentee. In one embodiment, relationship program 112 notifies the one or more mentors and the mentee of the mentor-mentee pairing via any suitable form of electronic communication.

Relationship program 112 determines post-action evaluation of relationship quality (216). In the exemplary embodiment, relationship program 112 determines post-action evaluation of relationship quality by capturing the quality of the mentor-mentee combination through, for example, a survey or questionnaire. Relationship program 112 utilizes historical feedback information provided by a mentor and a mentee to change the μ (mean/median) score previously discussed.

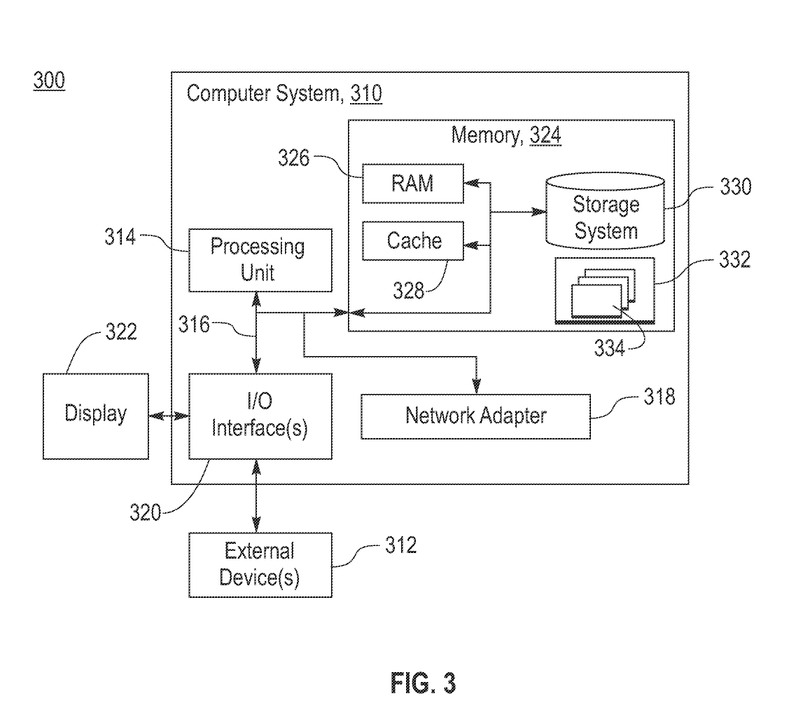

FIG. 3 is a block diagram, generally designated 300, depicting components of a data processing system (such as server 104 of data processing environment 100), in accordance with an embodiment of the present invention. It should be appreciated that FIG. 3 provides only an illustration of one implementation and does not imply any limitations with regard to the environments in that different embodiments can be implemented. Many modifications to the depicted environment can be made.

In the illustrative embodiment, server 104 in data processing environment 100 is shown in the form of a general-purpose computing device. The components of computer system 310 can include, but are not limited to, one or more processors or processing unit 314, memory 324, and bus 316 that couples various system components including memory 324 to processing unit 314.

Bus 316 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 310 typically includes a variety of computer system readable media. Such media can be any available media that is accessible by computer system 310, and it includes both volatile and non-volatile media, removable and non-removable media.

Memory 324 can include computer system readable media in the form of volatile memory, such as random access memory (RAM) 326 and/or cache memory 328. Computer system 310 can further include other removable/non-removable, volatile/non-volatile computer system storage media. By way of example only, storage system 330 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 316 by one or more data media interfaces. As will be further depicted and described below, memory 324 can include at least one computer program product having a set (e.g., at least one) of program modules that are configured to carry out the functions of embodiments of the invention.

Program/utility 332, having one or more sets of program modules 334, can be stored in memory 324 by way of example, and not limitation, as well as an operating system, one or more application programs, other program modules, and program data. Each of the operating systems, one or more application programs, other program modules, and program data, or some combination thereof, can include an implementation of a networking environment. Program modules 334 generally carry out the functions and/or methodologies of embodiments of the invention as described herein. Computer system 310 can also communicate with one or more external devices 312 such as a keyboard, a pointing device, a display 322, etc., or one or more devices that enable a user to interact with computer system 310 and any devices (e.g., network card, modem, etc.) that enable computer system 310 to communicate with one or more other computing devices. Such communication can occur via Input/Output (I/O) interface(s) 320. Still yet, computer system 310 can communicate with one or more networks such as a local area network (LAN), a general wide area network (WAN), and/or a public network (e.g., the Internet) via network adapter 318. As depicted, network adapter 318 communicates with the other components of computer system 310 via bus 316. It should be understood that although not shown, other hardware and software components, such as microcode, device drivers, redundant processing units, external disk drive arrays, RAID systems, tape drives, and data archival storage systems can be used in conjunction with computer system 310.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

The terminology used herein is for the purpose of describing particular embodiments only and is not intended to be limiting of the invention. It should be appreciated that any particular nomenclature herein is used merely for convenience and thus, the invention should not be limited to use solely in any specific function identified and/or implied by such nomenclature. Furthermore, as used herein, the singular forms of “a”, “an”, and “the” are intended to include the plural forms as well, unless the context clearly indicates otherwise.

What is claimed is:

1. A method for computational generation of organizational mentoring relationships, the method comprising:
determining, by one or more computer processors, a mentor pool and a mentee pool based, at least in part, on per-person domain metric data for each person in a general pool, wherein the mentor pool includes one or more mentors and the mentee pool includes one or more mentees;
determining, by one or more computer processors, a plurality of per-metric ranked mentor lists for each of the one or more mentees in the mentee pool, wherein the plurality of per-metric ranked mentor lists include one or more potential mentors;
determining, by one or more computer processors, a per-mentee fused rank list for each of the one or more mentees in the mentee pool, wherein the per-mentee fused rank list includes at least one of the one or more potential mentors from the plurality of per-metric ranked mentor lists;
determining, by one or more computer processors, based, at least in part, on the per-mentee fused rank list for each of the one or more mentees in the mentee pool, one or more cross-organizational mentorship assignments; and
establishing, by one or more computer processors, based, at least in part, on the one or more cross-organizational mentorship assignments, at least one mentor-mentee relationship for each of the one or more mentees in the mentee pool.

2. The method of claim 1, wherein determining a mentor pool and a mentee pool, further comprises mapping, by one or more computer processors, based, at least in part, on a relationship type, data relevant to one or more domain metrics to a corresponding marker from a plurality of pre-defined markers, wherein the plurality of pre-defined markers include one or more of:
an experiential similarity marker;
a perceived similarity marker;
an interaction facilitator marker; and
a personality compatibility marker.

3. The method of claim 1, wherein determining a mentor pool and a mentee pool, further comprises separating, by one or more computer processors, based, at least in part, on one or more key traits and one or more pool constraints, each person in the general pool into the mentor pool and the mentee pool, wherein separating each person in the general pool into the mentor pool and mentee pool includes identifying one or more high performers relative to one or more key traits.

4. The method of claim 1, wherein determining a plurality of per-metric ranked mentor lists for each of the one or more mentees in the mentee pool, further comprises ranking, by one or more computer processors, the one or more potential mentors in each of the plurality of per-metric ranked mentor lists against each other based, at least in part, on each of the one or more potential mentor's individual compatibility with a specific mentee relative to each of the one or more domain metrics constrained by each of the plurality of per-metric ranked mentor lists.

5. The method of claim 1, wherein determining a per-mentee fused rank list for each of the one or more mentees in the mentee pool, further comprises performing, by one or more computer processors, a global trust determination to fuse multiple rankings for each of the one or more potential mentors in each of the plurality of per-metric ranked mentor lists, the global trust determination indicating a trust factor.

6. The method of claim 5, wherein performing a global trust determination, further comprises determining, by one or more computer processors, a trust factor for each of the plurality of per-metric ranked mentor lists, wherein determining a trust factor includes determining a level of agreement between the plurality of per-metric ranked mentor lists and each of the one or more potential mentor's individual compatibility with a specific mentee relative to each of the one or more domain metrics constrained by each of the per-metric ranked mentor lists.

7. The method of claim 6, wherein determining a trust factor, further comprises determining, by one or more computer processors, a difference between a specific mentor-mentee compatibility score in a specific per-metric ranking and a mean score for the mentor-mentee relationship across the plurality of per-metric rankings, wherein the difference determines how much a specific domain metric disagrees with a mean metric for the specific mentor-mentee relationship.

8. The method of claim 7, wherein determining the difference between the specific mentor-mentee compatibility score in the specific per-metric ranking and the mean score for the mentor-mentee relationship across the plurality of per-metric rankings, further comprises determining a weighted sum and one or more weights that minimize the weighted sum, wherein the one or more weights that minimize the weighted sum indicate a trust factor.

9. The method of claim 1, wherein determining one or more cross-organizational mentorship assignments, further comprises solving, by one or more computer processors, a bipartite graph mapping problem under one or more constraints to balance quality of a mentor-mentee pairing with individual mentor load, wherein the bipartite graph mapping problem includes the one or more mentees oriented at the bottom of a map, the one or more mentors oriented at the top of the map, and one or more edges connecting each of the one or more mentees to at least one of the one or more mentors.

10. The method of claim 9, wherein solving the bipartite graph mapping problem, further comprises determining, by one or more computer processors, one or more edges to maximize a sum of a plurality of overall edge weights, under the one or more constraints that a degree of the mentor is less than a pre-specified maximum degree, and a degree of the mentee is less than a pre-specified maximum degree.

11. A computer program product for computational generation of organizational mentoring relationships, the computer program product comprising:
one or more computer readable storage media and program instructions stored on the one or more computer readable storage media, the program instructions comprising:
program instructions to determine, by one or more computer processors, a mentor pool and a mentee pool based, at least in part, on per-person domain metric data for each person in a general pool, wherein the mentor pool includes one or more mentors and the mentee pool includes one or more mentees;
program instructions to determine, by one or more computer processors, a plurality of per-metric ranked mentor lists for each of the one or more mentees in the mentee pool, wherein the plurality of per-metric ranked mentor lists include one or more potential mentors;
program instructions to determine, by one or more computer processors, a per-mentee fused rank list for each of the one or more mentees in the mentee pool, wherein the per-mentee fused rank list includes at least one of the one or more potential mentors from the plurality of per-metric ranked mentor lists;
program instructions to determine, by one or more computer processors, based, at least in part, on the per-mentee fused rank list for each of the one or more mentees in the mentee pool, one or more cross-organizational mentorship assignments; and
program instructions to establish, by one or more computer processors, based, at least in part, on the one or more cross-organizational mentorship assignments, at least one mentor-mentee relationship for each of the one or more mentees in the mentee pool.

12. The computer program product of claim 11, wherein program instructions to determine a mentor pool and a mentee pool, further comprising program instructions to map, by one or more computer processors, based, at least in part, on a relationship type, data relevant to one or more domain metrics to a corresponding marker from a plurality of pre-defined markers, wherein the plurality of pre-defined markers include one or more of:
an experiential similarity marker;
a perceived similarity marker;
an interaction facilitator marker; and
a personality compatibility marker.

13. The computer program product of claim 11, wherein program instructions to determine a mentor pool and a mentee pool, further comprising program instructions to separate, by one or more computer processors, based, at least in part, on one or more key traits and one or more pool constraints, each person in the general pool into the mentor pool and the mentee pool, wherein separating each person in the general pool into the mentor pool and mentee pool includes identifying one or more high performers relative to one or more key traits.

14. The computer program product of claim 11, wherein program instructions to determine a plurality of per-metric ranked mentor lists for each of the one or more mentees in the mentee pool, further comprising program instructions to rank, by one or more computer processors, the one or more potential mentors in each of the plurality of per-metric ranked mentor lists against each other based, at least in part, on each of the one or more potential mentor's individual compatibility with a specific mentee relative to each of the one or more domain metrics constrained by each of the plurality of per-metric ranked mentor lists.

15. The computer program product of claim 11, wherein program instructions to determine a per-mentee fused rank list for each of the one or more mentees in the mentee pool, further comprising program instructions to perform, by one or more computer processors, a global trust determination to fuse multiple rankings for each of the one or more potential mentors in each of the plurality of per-metric ranked mentor lists, the global trust determination indicating a trust factor.

16. The computer program product of claim 15, wherein program instructions to perform a global trust determination, further comprising program instructions to determine, by one or more computer processors, a trust factor for each of the plurality of per-metric ranked mentor lists, wherein determining a trust factor includes determining a level of agreement between the plurality of per-metric ranked mentor lists and each of the one or more potential mentor's individual compatibility with a specific mentee relative to each of the one or more domain metrics constrained by each of the per-metric ranked mentor lists.

17. The computer program product of claim 16, wherein program instructions to determine a trust factor, further comprising program instructions to determine, by one or more computer processors, a difference between a specific mentor-mentee compatibility score in a specific per-metric ranking and a mean score for the mentor-mentee relationship across the plurality of per-metric rankings, wherein the difference determines how much a specific domain metric disagrees with a mean metric for the specific mentor-mentee relationship.

18. The computer program product of claim 17, wherein program instructions to determine the difference between the specific mentor-mentee compatibility score in the specific per-metric ranking and the mean score for the mentor-mentee relationship across the plurality of per-metric rankings, further comprising program instructions to determine a weighted sum and one or more weights that minimize the weighted sum, wherein the one or more weights that minimize the weighted sum indicate a trust factor.

19. A computer system for computational generation of organizational mentoring relationships, the computer system comprising:
one or more computer readable storage media;
program instructions stored on at least one of the one or more computer readable storage media for execution by at least one of the one or more computer processors, the program instructions comprising:
program instructions to determine, by one or more computer processors, a mentor pool and a mentee pool based, at least in part, on per-person domain metric data for each person in a general pool, wherein the mentor pool includes one or more mentors and the mentee pool includes one or more mentees;
program instructions to determine, by one or more computer processors, a plurality of per-metric ranked mentor lists for each of the one or more mentees in the mentee pool, wherein the plurality of per-metric ranked mentor lists include one or more potential mentors;
program instructions to determine, by one or more computer processors, a per-mentee fused rank list for each of the one or more mentees in the mentee pool, wherein the per-mentee fused rank list includes at least one of the one or more potential mentors from the plurality of per-metric ranked mentor lists;
program instructions to determine, by one or more computer processors, based, at least in part, on the per-mentee fused rank list for each of the one or more mentees in the mentee pool, one or more cross-organizational mentorship assignments; and
program instructions to establish, by one or more computer processors, based, at least in part, on the one or more cross-organizational mentorship assignments, at least one mentor-mentee relationship for each of the one or more mentees in the mentee pool.

20. The computer system of claim 19, wherein determining one or more cross-organizational mentorship assignments, further comprises solving, by one or more computer processors, a bipartite graph mapping problem, wherein the bipartite graph mapping problem includes the one or more mentees oriented at the bottom of a map, the one or more mentors oriented at the top of the map, and one or more edges connecting each of the one or more mentees to at least one of the one or more mentors, under one or more constraints to balance quality of a mentor-mentee pairing with individual mentor load, wherein solving the bipartite graph mapping problem includes determining, by one or more computer processors, one or more edges to maximize a sum of a plurality of overall edge weights, under the one or more constraints that a degree of the mentor is less than a pre-specified maximum degree, and a degree of the mentee is less than a pre-specified maximum degree.
